(19) United States
(12) Patent Application Publication
(10) Pub. No.: US 2026/0095114 A1
(43) Pub. Date: Apr. 2, 2026

(54) MOTOR DRIVE DEVICE

(71) Applicants: SHINDENGEN ELECTRIC MANUFACTURING CO., LTD., Tokyo (JP); HONDA MOTOR CO., LTD., Tokyo (JP)

(72) Inventors: Takayuki Kondo, Asaka-shi (JP); Ryuto Hio, Asaka-shi (JP); Shintaro Okazaki, Asaka-shi (JP); Jun Kobayashi, Asaka-shi (JP); Satoshi Ohno, Tokyo (JP); Kazuya Konada, Tokyo (JP)

(21) Appl. No.: 19/340,945

(22) Filed: Sep. 26, 2025

(30) Foreign Application Priority Data
Sep. 27, 2024 (JP) 2024-169184

(51) Int. Cl. H02P 6/24; B60L 3/00; B60L 7/00; H02J 9/06; H02P 27/06

(52) U.S. Cl. CPC H02P 6/24; B60L 3/0046; B60L 3/0076; B60L 7/003; H02J 9/062; H02P 27/06; H02P 2207/05

(57) ABSTRACT

Braking of a motor is quickly activated when the supply of electric power stops. A motor drive device includes an inverter circuit configured to generate multi-phase motor drive signals for driving a motor with switching operations of switching elements, a relay switch unit capable of short-circuiting all phase signal lines for the multi-phase motor drive signals with relay switches, an inverter drive circuit configured to generate inverter drive signals for driving the switching operations of the switching elements from electric power supplied from a direct current (DC) power supply, a relay drive circuit configured to output a short-circuit instruction to short-circuit all the phase signal lines with the relay switch unit when braking of the motor is activated, and a backup power-supply circuit configured to short-circuit all the phase signal lines with the switching elements using a backup power supply for holding a predetermined voltage during at least a period until the relay switch unit short-circuits all the phase signal lines from the short-circuit instruction when the supply of the electric power from the DC power supply stops.

### CROSS-REFERENCE TO RELATED APPLICATION

Priority is claimed on Japanese Patent Application No. 2024-169184, filed Sep. 27, 2024, the content of which is incorporated herein by reference.

### BACKGROUND OF THE INVENTION

### Field of the Invention

The present invention relates to a motor drive device.

### Description of Related Art

In recent years, motor drive devices that apply dynamic braking to a motor such as a brushless motor by short-circuiting drive signal lines for respective phases of the motor between the phases with a relay switch have become known (see, for example, Patent Document 1). In such conventional motor drive devices, furthermore, technology for reducing a period until the dynamic braking is applied by putting the drive signal lines for the respective phases into a short-circuited state using switching elements of an inverter circuit during a period until the relay switch is in a conductive state is known.

### PATENT DOCUMENTS

[Patent Document 1] Japanese Unexamined Patent Application, First Publication No. 2013-179741

### SUMMARY OF THE INVENTION

However, for example, for use in an in-vehicle product, because electric power is supplied from a battery, there is a possibility that an inter-phase short-circuit process for short-circuiting drive signal lines with switching elements of an inverter circuit cannot be performed and dynamic braking cannot be quickly activated at the time of a power-supply failure in which the supply of electric power from the battery stops in the above-described conventional motor drive device.

The present invention has been made to solve the above problems and an objective of the present invention is to provide a motor drive device that can quickly activate braking of a motor even if the supply of electric power stops.

According to an aspect of the present invention for solving the above problems, there is provided a motor drive device including: an inverter circuit configured to generate multi-phase motor drive signals for driving a motor with switching operations of switching elements; a relay switch unit capable of short-circuiting all phase signal lines for the multi-phase motor drive signals with relay switches; an inverter drive circuit configured to generate inverter drive signals for driving the switching operations of the switching elements provided in the inverter circuit from electric power supplied from a direct current (DC) power supply; a relay drive circuit configured to output a short-circuit instruction to short-circuit all the phase signal lines with the relay switch unit when braking of the motor is activated; and a backup power-supply circuit charged with the electric power supplied from the DC power supply and configured to short-circuit all the phase signal lines with the switching elements using a backup power supply for holding a predetermined voltage during at least a period until the relay switch unit short-circuits all the phase signal lines from the short-circuit instruction when the supply of the electric power from the DC power supply stops.

Moreover, according to an aspect of the present invention, in the above-described motor drive device, the backup power-supply circuit may include the backup power supply including a power storage device charged with the electric power supplied from the DC power supply and a backflow prevention element that prevents a backflow of the electric power supplied from the DC power supply and configured to hold the predetermined voltage capable of driving the switching element during at least the period; and a short-circuit drive circuit using the backup power supply to output a short-circuit drive signal for short-circuiting all the phase signal lines with the switching element when the supply of the electric power from the DC power supply stops or when a failure in which the braking of the motor is required is detected.

Moreover, according to an aspect of the present invention, in the above-described motor drive device, the power storage device may be a capacitor.

Moreover, according to an aspect of the present invention, in the above-described motor drive device, the backflow prevention element may be a diode.

Moreover, according to an aspect of the present invention, the motor drive device may include a control unit configured to control the inverter drive circuit and the relay drive circuit, wherein, when the voltage of the DC power supply is less than or equal to a threshold value or when the failure in which the braking of the motor is required is detected, the control unit may stop an operation for controlling the switching element with the inverter drive circuit, cause the relay drive circuit to output the short-circuit instruction, and cause the short-circuit drive circuit to short-circuit all the phase signal lines with the switching elements.

Moreover, according to an aspect of the present invention, in the above-described motor drive device, the inverter circuit may include a pair of a first switching element and a second switching element connected in series between a high-potential-side first power-supply line through which drive power of the motor is supplied and a low-potential-side second power-supply line having a lower potential than the first power-supply line for each of a plurality of phases, and the backup power-supply circuit may short-circuit all the phase signal lines by putting all second switching elements connected to second power-supply lines into a conductive state.

Moreover, according to an aspect of the present invention, in the above-described motor drive device, the relay switch may be a normally closed switch that is in a conductive state when the supply of the electric power from the DC power supply stops.

Moreover, according to an aspect of the present invention, in the above-described motor drive device, the motor may be a three-phase brushless motor.

According to the present invention, when the supply of the electric power from the DC power supply stops, the backup power-supply circuit short-circuits all the phase signal lines with the switching elements of the inverter circuit using the backup power supply for holding the predetermined voltage during at least the period until the relay switch unit short-circuits all the phase signal lines from the short-circuit instruction to short-circuit all the phase signal lines for the multi-phase motor drive signals. Thereby, the motor drive device can quickly activate the braking of the motor even if the supply of the electric power stops.

### BRIEF DESCRIPTION OF THE DRAWINGS

FIG. 1 is a block diagram showing an example of a motor drive device according to an embodiment of the present invention.

FIG. 2 is an explanatory circuit diagram of an example of a short-circuit drive circuit according to the embodiment.

FIG. 3 is a flowchart showing an example of an operation of the motor drive device according to the present embodiment.

FIG. 4 is a timing chart showing an example of the operation of the motor drive device according to the present embodiment.

FIG. 5 is a timing chart showing an example of an operation of a conventional motor drive device.

### DETAILED DESCRIPTION OF THE INVENTION

A motor drive device according to an embodiment of the present invention will be described below with reference to the drawings.

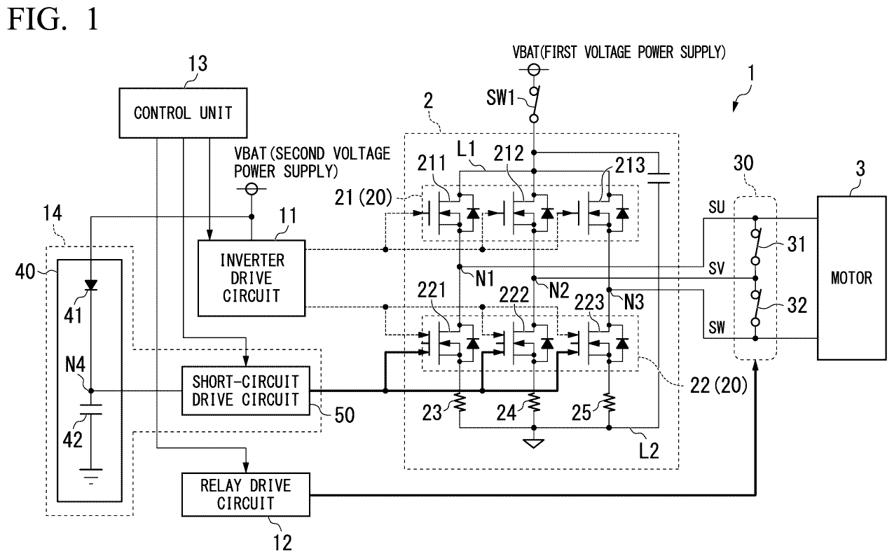

FIG. 1 is a block diagram showing an example of a motor drive device 1 according to the present embodiment.

As shown in FIG. 1, the motor drive device 1 includes an inverter circuit 2, an inverter drive circuit 11, a relay drive circuit 12, a control unit 13, a backup power-supply circuit 14, and a relay switch unit 30. The motor drive device 1 is, for example, a drive device that drives a motor 3 of an electric vehicle or the like.

The motor 3 is, for example, a three-phase brushless motor, and is driven by motor drive signals (SU, SV, and SW) of three phases (a U-phase, a V-phase, and a W-phase) output from the inverter circuit 2.

The inverter circuit 2 generates multi-phase (e.g., three-phase) motor drive signals (SU, SV, and SW) for driving the motor 3 with switching operations of switching elements 20 (211 to 213 and 221 to 223) to be described below. The inverter circuit 2 includes switching elements (211 to 213 and 221 to 223) and shunt resistors (23 to 25).

In addition, the inverter circuit 2 is arranged between a first voltage power supply (for example, having the same voltage as a battery power supply VBAT) for driving the motor 3 and a ground line via a switch SW1.

In addition, in the present embodiment, the switching elements 211 to 213 have the same configuration and correspond to the switching element 21 (the first switching element) on the high side (the high potential side) of the inverter circuit 2. When any high-side switching element provided in the inverter circuit 2 is indicated or unless otherwise specified, each of the switching elements 211 to 213 will be described as the high-side switching element 21 (the first switching element).

Moreover, the switching elements 221 to 223 have the same configuration and correspond to the switching element 22 (the second switching element) on the low side (the low potential side) of the inverter circuit 2. Each of the switching elements 221 to 223 will be described as the low-side switching element 22 (the second switching element) when any low-side switching element provided in the inverter circuit 2 is indicated or unless otherwise specified.

Moreover, the high-side switching element 21 and the low-side switching element 22 will be described as the switching element 20 when any switching element provided in the inverter circuit 2 is indicated or unless otherwise specified.

The inverter circuit 2 includes a pair of a high-side switching element 21 and a low-side switching element 22 connected in series between a high-potential side (high-side) power-supply line L1 (a first power-supply line) that supplies the drive power to the motor 3, and a low-potential-side (low-side) power-supply line L2 (a second power-supply line) having a lower potential than the power-supply line L1 for each of three phases (an example of a plurality of phases).

The switching elements 20 (211 to 213 and 221 to 223) are semiconductor switches such as N-channel metal-oxide semiconductor (NMOS) transistors and insulated gate bipolar transistors (IGBTs).

The switching element 211 and the switching element 221 are connected in series between the power-supply line L1 and the power-supply line L2 (the ground line), and a U-phase motor drive signal SU is output from a node N1 at a midpoint between the switching element 211 and the switching element 221.

Moreover, the switching element 212 and the switching element 222 are connected in series between the power-supply line L1 and the power-supply line L2 (the ground line), and a V-phase motor drive signal SV is output from a node N2 at a midpoint between the switching element 212 and the switching element 222.

Moreover, the switching element 213 and the switching element 223 are connected in series between the power-supply line L1 and the power-supply line L2 (the ground line), and a W-phase motor drive signal SW is output from the node N2 at a midpoint between the switching element 213 and the switching element 223.

In addition, a first voltage power supply (for example, having the same voltage as the battery power supply VBAT) for driving the motor 3 is connected to the power-supply line L1.

The high-side switching elements 21 (211 to 213) are connected to the power-supply line L1 (the first power-supply line) of the first voltage power supply (VBAT) that supplies electric power for driving the motor 3. The low-side switching elements 22 (221 to 223) are connected to the power-supply line L2 (the second power-supply line) of a low-potential-side power supply (ground).

The shunt resistor 23 detects an electric current flowing through the U-phase switching elements 20 (the switching element 211 and the switching element 221). The shunt resistor 23 is connected between the switching element 221 and the power-supply line L2 (the ground line).

Moreover, the shunt resistor 24 detects an electric current flowing through the V-phase switching elements 20 (the switching element 212 and the switching element 222). The shunt resistor 24 is connected between the switching element 222 and the power-supply line L2 (the ground line).

Moreover, the shunt resistor 25 detects an electric current flowing through the W-phase switching elements 20 (the switching element 213 and the switching element 223). The shunt resistor 25 is connected between the switching element 223 and the power-supply line L2 (the ground line).

The relay switch unit 30 can short-circuit all phase signal lines (the nodes N1 to N3) of three-phase motor drive signals (an example of multi-phase motor drive signals) (SU, SV, and SW) with relay switches (31 and 32). The relay switch unit 30 short-circuits all the phase signal lines (the nodes N1 to N3) for the motor drive signals (SU, SV, and SW) in response to a short-circuit instruction output by a relay drive circuit 12, which will be described below. The relay switch unit 30 includes the relay switch 31 and the relay switch 32.

The relay switch 31 and the relay switch 32 are normally closed switches that are in the conductive state (the ON state) when the supply of electric power from the battery power supply VBAT (the second voltage power supply) stops or when another failure in which an operation for controlling the braking of the motor 3 is required is detected.

The relay switch 31 is capable of short-circuiting the signal line (the node N1) for the U-phase motor drive signal SU and the signal line (the node N2) for the V-phase motor drive signal SV in accordance with a short-circuit instruction.

Moreover, the relay switch 32 is capable of short-circuiting the signal line (the node N2) for the V-phase motor drive signal SV and the signal line (the node N3) for the W-phase motor drive signal SW in accordance with a short-circuit instruction.

In addition, the battery power supply VBAT (an example of a DC power supply) is a power supply supplied from a battery such as a lithium-ion (Li-ion) battery. Although an example in which the battery power supply VBAT (the second voltage power supply) and the first voltage power supply for driving the motor 3 have the same voltage will be described in the present embodiment, the first voltage power supply and the second voltage power supply may have different voltages.

The inverter drive circuit 11 generates inverter drive signals (DS1 to DS6) for driving the switching operations of the switching elements 20 provided in the inverter circuit 2 from electric power supplied from the battery power supply VBAT. The inverter drive circuit 11 outputs the inverter drive signals (DS1 to DS6) that drive the switching operations of the switching elements (211 to 213 and 221 to 223) to the inverter circuit 2 on the basis of control signals (S1 to S6) from the control unit 13.

When the braking of the motor 3 is activated, the relay drive circuit 12 outputs a short-circuit instruction to short-circuit all the phase signal lines (the nodes N1 to N3) with the relay switch unit 30. When the motor 3 is in a normal control state instead of a braked state, the relay drive circuit 12, for example, outputs a high-state signal to a short-circuit instruction signal line and outputs a low-state signal as a short-circuit instruction according to a control process of the control unit 13 or a power-supply failure of the battery power supply VBAT.

The backup power-supply circuit 14 is charged with electric power supplied from the battery power supply VBAT. When the supply of electric power from the battery power supply VBAT stops (in the case of a power-supply failure), the backup power supply 40 is used to short-circuit all the phase signal lines (the nodes N1 to N3) with the switching elements 20. The backup power-supply circuit 14 includes a backup power supply 40 and a short-circuit drive circuit 50.

The backup power supply 40 is a power supply for holding a predetermined voltage during at least a period until the relay switch unit 30 short-circuits all the phase signal lines (the nodes N1 to N3) for the motor drive signals (SU, SV, and SW) from the short-circuit instruction of the relay drive circuit 12. Here, the predetermined voltage is, for example, a voltage that can drive the switching element 20 in an ON state. The backup power supply 40 includes a capacitor 42 (a power storage device) that is charged with the electric power supplied from the battery power supply VBAT and a diode 41 (a backflow prevention element) that prevents the electric power supplied from the battery power supply VBAT from flowing backward.

The diode 41 (the example of the backflow prevention element) has an anode terminal connected to the battery power supply VBAT and a cathode terminal connected to a node N4. The diode 41 prevents the charging voltage of the capacitor 42 from flowing backwards in the case of the power-supply failure of the battery power supply VBAT.

The capacitor 42 (an example of a power storage device) is arranged between the node N4 and the ground line and charged with electric power supplied from the battery power supply VBAT. Moreover, the electric power with which the capacitor 42 is charged is used as drive power for the switching element 20 that short-circuits all the phase signal lines (the nodes N1 to N3) for the motor drive signals (SU, SV, and SW) at the time of the power-supply failure of the battery power supply VBAT.

When the supply of electric power from the battery power supply VBAT stops or when another failure in which an operation for controlling the braking of the motor 3 is required is detected, the short-circuit drive circuit 50 uses the backup power supply 40 to output a short-circuit drive signal for short-circuiting all the phase signal lines (the nodes N1 to N3) for the motor drive signals (SU, SV, and SW) with the switching elements 20. In the case of the power-supply failure of the battery power supply VBAT or when there is a short-circuit request from the control unit 13 to short-circuit all the phase signal lines (the nodes N1 to N3), the short-circuit drive circuit 50 outputs the short-circuit drive signal to the inverter circuit 2.

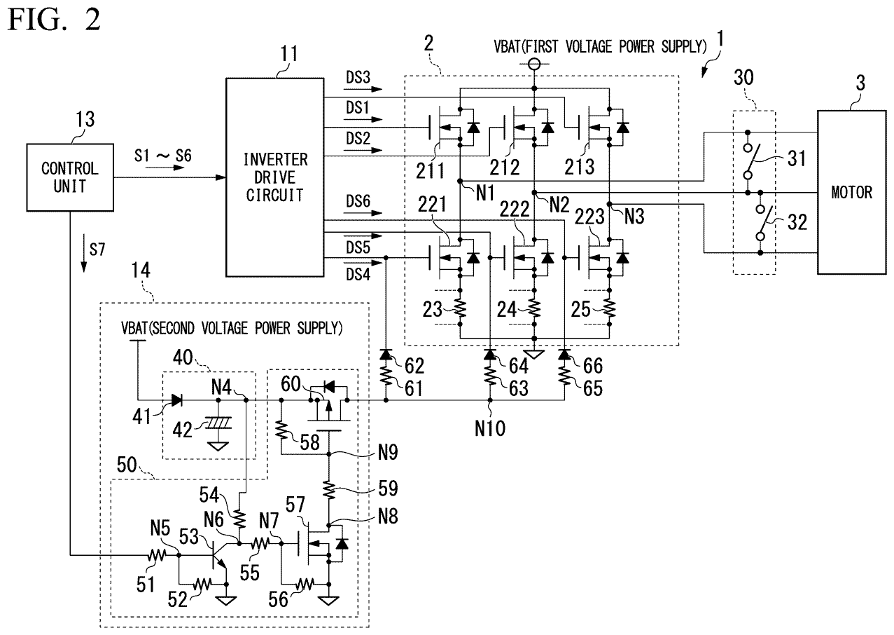

In addition, a detailed configuration of the short-circuit drive circuit 50 will be described below with reference to FIG. 2.

The control unit 13 is, for example, a microcontroller including a central processing unit (CPU), and performs an overall control process for the motor drive device 1. The control unit 13 controls the inverter circuit 2 via the inverter drive circuit 11 to output the motor drive signals (SU, SV, and SW), and controls the drive of the motor 3.

Moreover, the control unit 13 controls the motor 3 so that the motor 3 is in a braked state using the relay drive circuit 12 and the backup power-supply circuit 14. The control unit 13 controls the relay drive circuit 12 and the backup power-supply circuit 14 so that all the phase signal lines (the nodes N1 to N3) for the motor drive signals (SU, SV, and SW) are short-circuited.

Moreover, when the voltage of the battery power supply VBAT is less than or equal to a threshold value (less than or equal to a threshold value Vth), the control unit 13 stops an operation for controlling the switching element 20 with the inverter drive circuit 11, outputs a short-circuit instruction to the relay drive circuit 12, and causes the short-circuit drive circuit to short-circuit all the phase signal lines (the nodes N1 to N3) for the motor drive signals (SU, SV, and SW) with the switching elements 20. Here, the threshold value Vth is, for example, a voltage that is lower than a minimum rated voltage of the battery power supply VBAT and allows the control unit 13 to operate.

Next, a detailed configuration of the above-described short-circuit drive circuit 50 will be described with reference to FIG. 2.

FIG. 2 is an explanatory circuit diagram of an example of the short-circuit drive circuit 50 in the present embodiment.

As shown in FIG. 2, the short-circuit drive circuit 50 includes a resistor 51, a resistor 52, an NPN transistor 53, resistors 54 to 56, an NMOS transistor 57, a resistor 58, a resistor 59, and a PMOS transistor 60.

The resistor 51 is arranged between a signal line of a control signal S7 of the control unit 13 and a node N5 and generates an electric current of a base of the NPN transistor 53. Moreover, the resistor 51 causes the node N5 to be held in a high state when the control signal S7 is in a high state.

The resistor 52 is arranged between the node N5 and the ground line, and functions as a pull-down resistor to hold the node N5 in the low state when the control signal S7 is in the low state or in the case of the power-supply failure of the battery power supply VBAT.

The NPN transistor 53 is an NPN bipolar transistor, a collector terminal is connected to a node N6, a base terminal is connected to the node N5, and an emitter terminal is connected to the ground line. The NPN transistor 53 is turned on (or in a conductive state) when the control signal S7 is in the high state, and turned off (or in a non-conductive state) when the control signal S7 is in the low state or when the power-supply failure of the battery power supply VBAT occurs.

The resistor 54 is connected between the node N6 and the node N4, which is the output terminal of a backup power-supply voltage of the backup power supply 40, and functions as a pull-up resistor for the backup power-supply voltage. The resistor 54 causes the node N6 to be hold at the backup power-supply voltage of the backup power supply 40 when the NPN transistor 53 is in the OFF state.

The resistor 55 is arranged between the node N6 and a node N7. The resistor 56 is arranged between the node N7 and the ground line. The resistors 55 and 56 function as voltage dividing resistors and generate a drive voltage for an NMOS transistor (to be described below) from the backup power-supply voltage of the backup power supply 40 according to a resistance ratio between the resistors 55 and 56.

The NMOS transistor 57 is an N-channel MOS transistor and has a drain terminal connected to a node N9, a gate terminal connected to the node N7, and a source terminal connected to the ground signal line. When the NPN transistor 53 is in the ON state, the NMOS transistor 57 is turned off when the node N7 is in the low state. Moreover, when the NPN transistor 53 is in the OFF state, the NMOS transistor 57 is turned on when the node N7 is in the high state.

The resistor 58 is arranged between the node N9 and the node N4, which is the output terminal of the backup power-supply voltage of backup power supply 40, and functions as a pull-up resistor for the backup power-supply voltage. The resistor 58 causes the node N9 to be held at the backup power-supply voltage of the backup power supply 40 when the NMOS transistor 57 is in the OFF state.

The resistor 59 is arranged between the node N9 and a node N8, which is a drain terminal of the NMOS transistor 57 and limits an electric current flowing through the NMOS transistor 57. A resistance value of the resistor 59 is adjusted so that the node N9 is in the low state when the NMOS transistor 57 is in the ON state and the node N9 is in the high state when the NMOS transistor 57 is in the ON state.

The PMOS transistor 60 is a P-channel MOS transistor, and has a drain terminal connected to a node N10, a gate terminal connected to the node N9, and a source terminal connected to the node N4 which is an output terminal of the backup power-supply voltage of the backup power supply 40. The PMOS transistor 60 is in the OFF state when the node N9 is in the high state. Moreover, when the node N9 is in the low state, the PMOS transistor 60 is in the ON state and outputs a backup power-supply voltage of the backup power supply 40 to the node N10.

The node N10, which is an output terminal of the short-circuit drive circuit 50, is connected to a gate terminal (a control terminal) of the switching element 221 via a resistor 61 and a diode 62. Likewise, the node N10 is connected to a gate terminal (a control terminal) of the switching element 222 via a resistor 63 and a diode 64 and connected to a gate terminal (a control terminal) of the switching element 223 via a resistor 65 and a diode 66.

When the PMOS transistor 60 is in the ON state and the backup power-supply voltage of the backup power supply 40 is supplied to the node N10, the low-side switching elements 22 (221 to 223) are in the ON state, and all the phase signal lines (the nodes N1 to N3) for the motor drive signals (SU, SV, and SW) are short-circuited.

The resistor 61 limits the electric current flowing from the node N10 to the gate terminal of the switching element 221. The diode 62 is connected to the resistor 61 in series and has an anode terminal connected to one end of the resistor 61 and a cathode terminal connected to the gate terminal of the switching element 221 so that the forward direction is from the node N10 to the gate terminal of the switching element 221. The diode 62 prevents an electric current from flowing back from the gate terminal of the switching element 221 to the short-circuit drive circuit 50.

Moreover, the resistor 63 limits the electric current flowing from the node N10 to the gate terminal of the switching element 222. The diode 64 is connected to the resistor 63 in series and has an anode terminal connected to one end of the resistor 63 and a cathode terminal connected to the gate terminal of the switching element 222 so that the forward direction is from the node N10 to the gate terminal of the switching element 222. The diode 64 prevents an electric current from flowing back from the gate terminal of the switching element 222 to the short-circuit drive circuit 50.

Moreover, the resistor 65 limits the electric current flowing from the node N10 to the gate terminal of the switching element 223. The diode 66 is connected to the resistor 65 in series and has an anode terminal connected to one end of the resistor 65 and a cathode terminal connected to the gate terminal of the switching element 223 so that the forward direction is from the node N10 to the gate terminal of the switching element 223. The diode 66 prevents an electric current from flowing back from the gate terminal of the switching element 223 to the short-circuit drive circuit 50.

In addition, when the inverter circuit 2 is normally controlled by the inverter drive circuit 11, the inverter drive circuit 11 outputs the inverter drive signals DS1 to DS6 in accordance with the control signals S1 to S6 output from the control unit 13.

A signal line for the inverter drive signal DS1 is connected to the gate terminal of the switching element 211. Moreover, a signal line for the inverter drive signal DS2 is connected to the gate terminal of the switching element 212. A signal line for the inverter drive signal DS3 is connected to the gate terminal of the switching element 213.

Moreover, a signal line for the inverter drive signal DS4 is connected to the gate terminal of the switching element 221 and the cathode terminal of the diode 62. Moreover, a signal line for the inverter drive signal DS5 is connected to the gate terminal of the switching element 222 and the cathode terminal of the diode 64. A signal line for the inverter drive signal DS6 is connected to the gate terminal of the switching element 223 and the cathode terminal of the diode 66.

Next, an operation of the motor drive device 1 according to the present embodiment will be described with reference to the drawings.

First, an operation of the short-circuit drive circuit 50 of the backup power-supply circuit 14 will be described with reference to FIG. 2.

In the short-circuit drive circuit 50 shown in FIG. 2, in a normal operating state when electric power is normally supplied from the battery power supply VBAT, because the control unit 13 puts the control signal S7 into the high state, the node N5 is in the high state and the NPN transistor 53 is in the ON state. Subsequently, the NPN transistor 53 is in the ON state, such that the node N7 is in the low state and the NMOS transistor 57 is in the OFF state.

Subsequently, the NMOS transistor 57 is in the OFF state, the node N9 is in the high state and the PMOS transistor 60 is in the OFF state. Thereby, the short-circuit drive circuit 50 is not affected by the operation of the low-side switching element 22 of the inverter circuit 2 in the normal operating state.

Moreover, in the short-circuit drive circuit 50, when there is a power-supply failure in which electric power is not supplied from the battery power supply VBAT, for example, when the battery is disconnected or the like, if the operation of the control unit 13 stops and the voltage of the control signal S7 decreases, the node N5 is in the low state due to the resistor 52, and the NPN transistor 53 is in the OFF state. Subsequently, when the NPN transistor 53 is in the OFF state, the node N7 is in the high state and the NMOS transistor 57 is in the ON state.

Subsequently, the NMOS transistor 57 is in the ON state, such that the node N9 is in the low state and the PMOS transistor 60 is in the ON state. Thereby, the node N4 of the backup power supply 40 is connected to the node N10 and the switching elements 22 (221 to 223) are in the ON state. In this way, when a power-supply failure occurs, the short-circuit drive circuit 50 turns on the switching element 22 on the low side of the inverter circuit 2, and short-circuits all the phase signal lines (the nodes N1 to N3) for the motor drive signals (SU, SV, and SW).

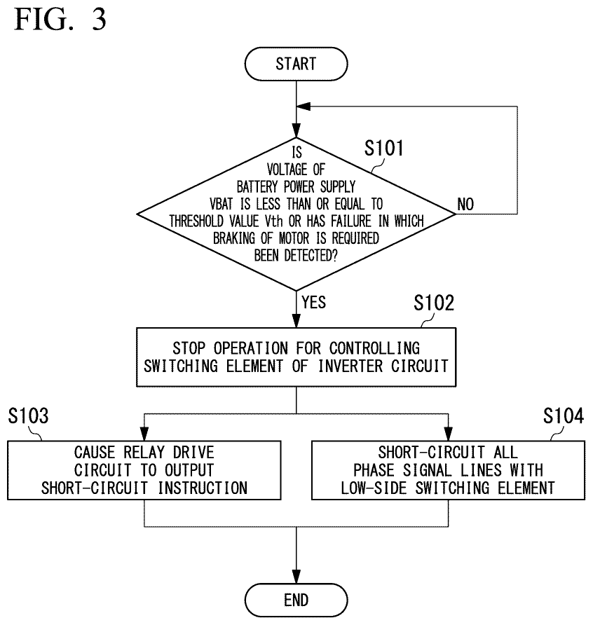

Next, an operation of the control unit 13 of the motor drive device 1 will be described with reference to FIG. 3.

FIG. 3 is a flowchart showing an example of the operation of the motor drive device 1 according to the present embodiment. Here, an operation of the control unit 13 when the motor drive device 1 detects a voltage drop of the battery power supply VBAT due to, for example, a power-supply failure, will be described.

As shown in FIG. 3, the control unit 13 of the motor drive device 1 first determines whether the voltage of the battery power supply VBAT is less than or equal to the threshold value Vth or whether or not a failure in which the braking of the motor 3 is required has been detected (step S101). In addition, the control unit 13 detects the voltage of the battery power supply VBAT using, for example, an analog to digital converter (ADC) (not shown). Moreover, when a failure in which the braking of the motor 3 is required has been detected, this corresponds to a case where there is a braking control command from the control unit 13. When the voltage of the battery power supply VBAT is less than or equal to the threshold value Vth or when a failure in which the braking of the motor 3 is required has been detected (step S101: YES), the control unit 13 moves the process to step S102. When the voltage of the battery power supply VBAT is greater than the threshold value Vth or when a failure in which the braking of the motor 3 is required has not been detected (step S101: NO), the control unit 13 returns the process to step S101.

In step S102, the control unit 13 stops an operation for controlling the switching elements 20 of the inverter circuit 2. The control unit 13 controls the control signals S1 to S6 so that all the switching elements 20 are in the OFF state and the inverter drive signals DS1 to DS6 are in the low state, and outputs the control signals S1 to S6 to the inverter drive circuit 11.

Subsequently, the control unit 13 executes the processing of step S103 and the processing of step S104 in parallel.

In step S103, the control unit 13 causes the relay drive circuit 12 to output a short-circuit instruction. The control unit 13 causes the relay drive circuit 12 to output the short-circuit instruction according to a control signal, and the relay switch unit 30 short-circuits all the phase signal lines (the nodes N1 to N3) for the motor drive signals (SU, SV, and SW).

In response to the short-circuit instruction, in the relay switch unit 30, the relay switches (31 and 32) are not immediately closed and a certain period of time (for example, several tens of milliseconds (ms)) is required until the relay switches (31 and 32) are closed.

Moreover, in step S104, the control unit 13 short-circuits all the phase signal lines (the nodes N1 to N3) with the low-side switching element 22. The control unit 13 instructs the short-circuit drive circuit 50 to short-circuit all the phase signal lines (the nodes N1 to N3) with the low-side switching elements 22 according to the control signal S7, and the short-circuit drive circuit 50 turns on the low-side switching elements 22 (221 to 223) to short-circuit all the phase signal lines (the nodes N1 to N3) for the motor drive signals (SU, SV, and SW). After the processing of steps S103 and S104, the control unit 13 ends the process.

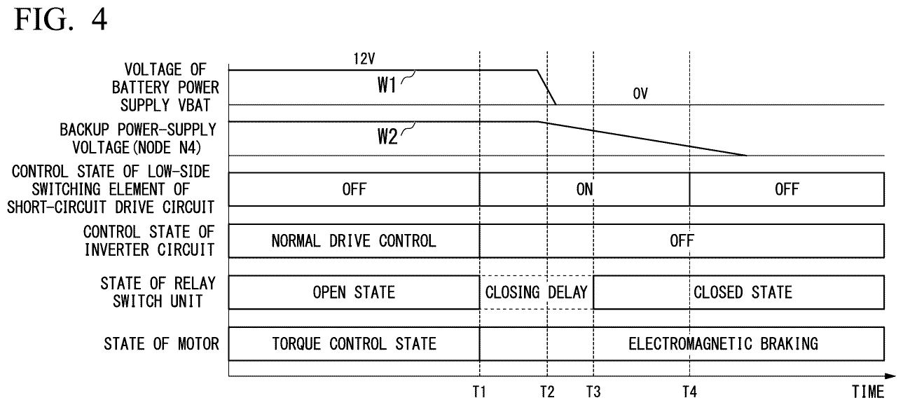

Next, an operation of the motor drive device 1 according to the present embodiment will be described with reference to FIG. 4. Here, an overall operation of the motor drive device 1 in the case where there is a power-supply failure of the battery power supply VBAT when the motor 3 is in a braking control state in response to an instruction from the control unit 13 will be described.

FIG. 4 is a timing chart showing an example of the operation of the motor drive device 1 according to the present embodiment.

In FIG. 4, the horizontal axis represents time and the vertical axis represents, from top to bottom, a waveform W1 of a voltage of the battery power supply VBAT, a waveform W2 of a voltage of the backup power supply 40 (a voltage at the node N4), a control state of the low-side switching element 22 of the short-circuit drive circuit 50, a control state of the inverter circuit 2, a state of the relay switch unit 30, and a state of the motor 3.

In the example shown in FIG. 4, an example in which a power-supply failure of the battery power supply VBAT occurs immediately after a change from normal drive control to braking control in the inverter circuit 2 is shown.

In FIG. 4, in the initial state, it is assumed that the control state of the low-side switching element 22 of the short-circuit drive circuit 50 is the OFF state, the control state of the inverter circuit 2 is the normal drive control state, the state of the relay switch unit 30 is the open state, and the motor 3 is in the torque control state.

Subsequently, at time T1, the control unit 13 changes the state of the inverter circuit 2 to the braking control state, and causes the relay drive circuit 12 to output a short-circuit instruction to the relay switch unit 30. The control unit 13 stops an operation for controlling the switching element 20 with the inverter drive circuit 11, sets the control state of the inverter circuit to the OFF state, and causes the short-circuit drive circuit 50 to short-circuit all the phase signal lines (the nodes N1 to N3) with the low-side switching element 22 according to the control signal S7.

In addition, at time T1, because it takes a certain period of time for the relay switches (31 and 32) to close, the state of the relay switch unit 30 has not yet transitioned to the closed state.

Subsequently, at time T2, if a power-supply failure of the battery power supply VBAT occurs and the voltage of the battery power supply VBAT decreases (see the waveform W1), the control unit 13 stops an operation for controlling the switching element 20 with the inverter drive circuit 11, maintains the control state of the inverter circuit in the OFF state, and maintains a state in which the short-circuit drive circuit 50 short-circuits all the phase signal lines (the nodes N1 to N3) with the low-side switching element 22 according to the control signal S7. Thereby, the control state of the low-side switching element 22 of the short-circuit drive circuit 50 is maintained in the ON state.

In addition, when the battery power supply VBAT drops to a level at which the control unit 13 cannot operate, the control signal S7 is in the low state. In this case, because the short-circuit drive circuit 50 can operate according to the voltage of the backup power supply 40 (the voltage of the node N4), the ON state of the switching element 22 may be maintained and the electromagnetically braked state of the motor 3 may be maintained.

Subsequently, at time T3, the relay switch unit 30 transitions to the closed state, and all the phase signal lines (the nodes N1 to N3) are short-circuited by both the relay switch unit 30 and the short-circuit drive circuit 50.

Subsequently, at time T4, when the voltage of the backup power supply 40 (the voltage of node N4) drops to a level at which the low-side switching element 22 cannot be driven, the short-circuit drive circuit 50 can no longer maintain the ON state of the switching element 22, and the control state of the switching element 22 becomes the OFF state. However, because the relay switches (31 and 32) of the relay switch unit 30 are normally closed, the relay switches (31 and 32) maintain all the phase signal lines (the nodes N1 to N3).

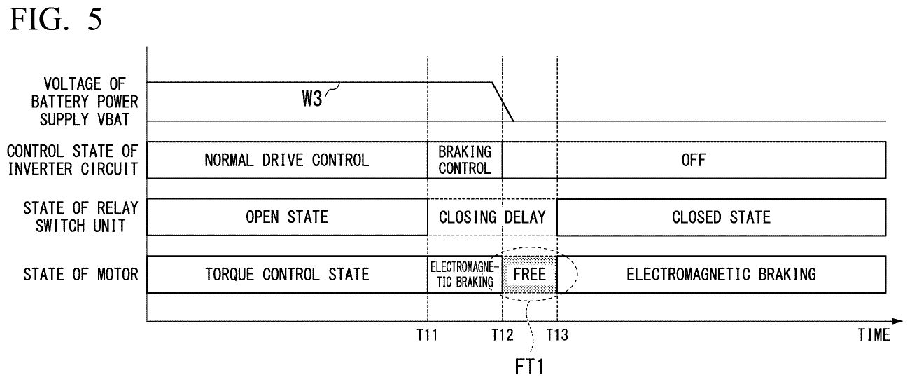

Next, for the comparison with the motor drive device 1 of the present embodiment, an operation of a conventional motor drive device that does not include the backup power-supply circuit 14 of the present embodiment will be described with reference to FIG. 5.

FIG. 5 is a timing chart showing an example of the operation of the conventional motor drive device.

In FIG. 5, the horizontal axis represents time and the vertical axis represents, from the top, a waveform W3 of the voltage of the battery power supply VBAT, a control state of the inverter circuit 2, a state of the relay switch unit 30, and a state of the motor 3.

In the example shown in FIG. 5, as in FIG. 4, an example in which a power-supply failure of the battery power supply VBAT occurs immediately after a change from normal drive control to braking control in the inverter circuit 2 is shown.

In FIG. 5, in the initial state, it is assumed that the control state of the inverter circuit 2 is the normal drive control state, the state of the relay switch unit 30 is the open state, and the motor 3 is in the torque control state.

Subsequently, at time T11, the control unit 13 changes the state of the inverter circuit 2 to a braking control state, and causes the relay drive circuit 12 to output a short-circuit instruction to the relay switch unit 30. The control unit 13 changes the states of the inverter drive signals DS1 to DS3 to the low state and changes the states of the inverter drive signals DS4 to DS6 to the high state via the inverter drive circuit 11, thereby putting the motor 3 into the electromagnetically braked state.

In addition, at time T11, because it takes a certain period of time for the relay switches (31 and 32) to close, the state of the relay switch unit 30 has not yet transitioned to the closed state.

Subsequently, at time T12, when a power-supply failure of the battery power supply VBAT occurs and the voltage of the battery power supply VBAT drops (see the waveform W3), the control unit 13 becomes inoperable, the ON state of the switching element 22 can no longer be maintained, and the motor 3 is in a free state.

Subsequently, at time T13, the relay switch unit 30 transitions to a closed state, and all the phase signal lines (the nodes N1 to N3) are short-circuited by both the relay switch unit 30 and the short-circuit drive circuit 50. Thereby. the motor 3 is in the electromagnetically braked state.

As described above, in the conventional motor drive device, there is a period of the free state (a free period FT1) during which the braked state of the motor 3 is temporarily released.

In contrast, in the motor drive device 1 of the present embodiment, as shown in FIG. 4, there is no period during which the motor 3 is in a free state (the free period FT1) as in the conventional motor drive device.

As described above, the motor drive device 1 according to the present embodiment includes the inverter circuit 2, the relay switch unit 30, the inverter drive circuit 11, the relay drive circuit 12, and the backup power-supply circuit 14. The inverter circuit 2 generates multi-phase motor drive signals (SU, SV, and SW) for driving the motor 3 by switching the switching elements 20 (211 to 213 and 221 to 223). The relay switch unit 30 can short-circuit all the phase signal lines (the nodes N1 to N3) of the multi-phase motor drive signals (SU, SV, and SW) with the relay switches (31 and 32). The inverter drive circuit 11 generates the inverter drive signals (DS1 to DS6) for driving the switching operations of the switching elements 20 provided in the inverter circuit 2 from electric power supplied from the battery power supply VBAT (the DC power supply). When the braking of the motor 3 is activated, the relay drive circuit 12 outputs the short-circuit instruction to short-circuit all the phase signal lines (the nodes N1 to N3) via the relay switch unit 30. The backup power-supply circuit 14 uses the backup power supply 40 to short-circuit all the phase signal lines (the nodes N1 to N3) with the switching elements 20. The backup power supply 40 is charged with electric power supplied from the battery power supply VBAT, and holds a predetermined voltage during at least a period until the relay switch unit 30 short-circuits all the phase signal lines (the nodes N1 to N3) from the short-circuit instruction when the supply of electric power from the battery power supply VBAT stops.

Thereby, the motor drive device 1 according to the present embodiment short-circuits all the phase signal lines (the nodes N1 to N3) for the motor drive signals (SU, SV, and SW) with the switching elements 20 of the inverter circuit 2 using the backup power supply 40. Therefore, the motor drive device can quickly apply the braking of the motor 3 even if the supply of electric power stops.

Moreover, in the present embodiment, the backup power-supply circuit 14 includes the backup power supply 40 and the short-circuit drive circuit 50. The backup power supply 40 includes the electric storage device (the capacitor 42) charged with the electric power supplied from the battery power supply VBAT, and the backflow prevention element (the diode 41) that prevents a backflow of the electric power supplied from the battery power supply VBAT, and holds the predetermined voltage capable of driving the switching element 20 during at least the period until the relay switch unit 30 short-circuits all the phase signal lines (the nodes N1 to N3) from the short-circuit instruction. When the supply of electric power from the battery power supply VBAT stops or when a failure in which the braking of the motor 3 is required is detected, the short-circuit drive circuit 50 uses the backup power supply 40 to output a short-circuit drive signal for causing the switching elements 20 (the low-side switching elements 22) to short-circuit all the phase signal lines (the nodes N1 to N3) of the motor drive signals (SU, SV, and SW).

Thereby, the motor drive device 1 according to the present embodiment includes the backup power supply 40 and the short-circuit drive circuit 50, and can quickly and reliably activate the braking of the motor 3 even if the supply of electric power stops.

Moreover, in the present embodiment, the power storage device is the capacitor 42. The backflow prevention element is the diode 41.

Thereby, the motor drive device 1 according to the present embodiment can implement the backup power supply 40 with a simple configuration using the diode 41 and the capacitor 42.

Moreover, the motor drive device 1 according to the present embodiment includes the control unit 13 that controls the inverter drive circuit 11 and the relay drive circuit 12. When the voltage of the battery power supply VBAT is less than or equal to a threshold value or when a failure in which the braking of the motor 3 is required is detected, the control unit 13 stops an operation for controlling the switching element 20 with the inverter drive circuit 11 and outputs a short-circuit instruction to the relay drive circuit 12, and also causes the short-circuit drive circuit 50 to short-circuit all the phase signal lines (the nodes N1 to N3) for the motor drive signals (SU, SV, and SW) with the switching elements 20.

Thereby, in the motor drive device 1 according to the present embodiment, after the control unit 13 stops an operation for controlling the switching element 20 with the inverter drive circuit 11, the short-circuit drive circuit 50 short-circuits all the phase signal lines (the nodes N1 to N3) for the motor drive signals (SU, SV, and SW). Therefore, the motor drive device 1 according to the present embodiment can avoid a conflict between the process of controlling the switching element 20 between the inverter drive circuit 11 and the short-circuit drive circuit 50, and can safely short-circuit all the phase signal lines (the nodes N1 to N3) for the motor drive signals (SU, SV, and SW) and quickly activate the braking of the motor 3.

Moreover, in the present embodiment, the inverter circuit 2 includes a pair of the high-side switching element 21 (the first switching element) and the low-side switching element 22 (the second switching element) connected in series between a high-potential power-supply line L1 (the first power-supply line) that supplies drive power to the motor 3 and a low-potential power-supply line L2 (the second power-supply line) having a lower potential than the power-supply line L1 for each of a plurality of phases (e.g., three phases). The backup power-supply circuit 14 puts all the low-side switching elements 22 connected to the power-supply line L2 into the conductive state (the ON state), thereby short-circuiting all the phase signal lines (the nodes N1 to N3) for the motor drive signals (SU, SV, and SW).

Thereby, the motor drive device 1 according to the present embodiment uses the low-side switching elements 22 to short-circuit all the phase signal lines (the nodes N1 to N3) for the motor drive signals (SU, SV, and SW), and can appropriately put the motor 3 into a braked state according to a simpler configuration.

Moreover, in the present embodiment, the relay switches (31 and 32) are normally closed switches that are in the conductive state when the supply of electric power from the battery power supply VBAT stops.

Thereby, in the motor drive device 1 according to the present embodiment, because the relay switches (31 and 32) are normally closed switches, when the supply of electric power stops, all the phase signal lines (the nodes N1 to N3) can be reliably short-circuited and therefore the motor 3 is put into the braked state.

Moreover, in the present embodiment, the motor 3 is a three-phase brushless motor.

Thereby, the motor drive device 1 according to the present embodiment, for example, can quickly activate the braking of the motor 3 when the supply of electric power stops or when the control unit issues an instruction due to other failure detection in various types of devices using a three-phase brushless motor (e.g., an electric vehicle or the like).

The present invention is not limited to the above-described embodiment, and modifications may be made without departing from the scope and spirit of the present invention.

For example, an example in which the backup power-supply circuit 14 turns on all the low-side switching elements 22 of the inverter circuit 2 to short-circuit all the phase signal lines (the nodes N1 to N3) for the motor drive signals (SU, SV, and SW) has been described in the above-described embodiment, but the present invention is not limited thereto. The backup power-supply circuit 14 may turn on all the high-side switching elements 21 instead of the low-side switching elements 22 to short-circuit all the phase signal lines (the nodes N1 to N3) for the motor drive signals (SU, SV, and SW).

Although the motor 3 is a three-phase brushless motor in the above embodiment, the present invention is not limited thereto and the motor 3 may be another type of motor. The motor 3 may be, for example, a motor that uses a motor drive signal having four or more phases.

Although a circuit example of the backup power-supply circuit 14 (the backup power supply 40 and the short-circuit drive circuit 50) has been described with reference to FIG. 2 in the above embodiment, the present invention is not limited thereto and the backup power-supply circuit 14 may be a circuit of another configuration. For example, the backup power supply 40 may use another power storage device such as a secondary battery instead of the capacitor 42. Moreover, the backup power supply 40 may use another backflow prevention element such as a thyristor instead of the diode 41.

The above-described motor drive device 1 internally has a computer system inside. The processing steps of the control unit 13 described above are stored in a computer-readable recording medium in the form of a program, and the computer reads and executes this program to perform the above processing. Here, the computer-readable recording medium refers to a magnetic disk, a magneto-optical disk, a CD-ROM, a DVD-ROM, a semiconductor memory, or the like. Moreover, the computer program may be distributed to a computer via a communication line, and the computer, which has received the distributed program, may execute the program.

### EXPLANATION OF REFERENCES

1 Motor drive device
2 Inverter circuit
3 Motor
11 Inverter drive circuit
12 Relay drive circuit
13 Control unit
14 Backup power-supply circuit
51, 52, 54, 55, 56, 58, 59, 61, 63, 65 Resistor
41, 62, 64, 66 Diode
20, 211, 212, 213, 221, 222, 223 Switching element
21 High-side switching element
22 Low-side switching element
23, 24, 25 Shunt resistor
30 Relay switch unit
31, 32 Relay switch
40 Backup power supply
42 Capacitor
50 Short-circuit drive circuit
53 NPN transistor
57 NMOS transistor
60 PMOS transistor

What is claimed is:

1. A motor drive device comprising:
an inverter circuit configured to generate multi-phase motor drive signals for driving a motor with switching operations of switching elements;
a relay switch unit capable of short-circuiting all phase signal lines for the multi-phase motor drive signals with relay switches;
an inverter drive circuit configured to generate inverter drive signals for driving the switching operations of the switching elements provided in the inverter circuit from electric power supplied from a direct current (DC) power supply;
a relay drive circuit configured to output a short-circuit instruction to short-circuit all the phase signal lines with the relay switch unit when braking of the motor is activated; and
a backup power-supply circuit configured to be charged with the electric power supplied from the DC power supply, and the backup power-supply circuit configured to short-circuit all the phase signal lines with the switching elements using a backup power supply for holding a predetermined voltage during at least a period until the relay switch unit short-circuits all the phase signal lines from the short-circuit instruction when the supply of the electric power from the DC power supply stops.

2. The motor drive device according to claim 1, wherein the backup power-supply circuit comprises:
the backup power supply including a power storage device charged with the electric power supplied from the DC power supply and a backflow prevention element that prevents a backflow of the electric power supplied from the DC power supply and configured to hold the predetermined voltage capable of driving the switching element during at least the period; and
a short-circuit drive circuit using the backup power supply to output a short-circuit drive signal for short-circuiting all the phase signal lines with the switching element when the supply of the electric power from the DC power supply stops or when a failure in which the braking of the motor is required is detected.

3. The motor drive device according to claim 2, wherein the power storage device is a capacitor.

4. The motor drive device according to claim 2, wherein the backflow prevention element is a diode.

5. The motor drive device according to claim 2, comprising a control unit configured to control the inverter drive circuit and the relay drive circuit,
wherein, when the voltage of the DC power supply is less than or equal to a threshold value or when the failure in which the braking of the motor is required is detected, the control unit stops an operation for controlling the switching element with the inverter drive circuit, causes the relay drive circuit to output the short-circuit instruction, and causes the short-circuit drive circuit to short-circuit all the phase signal lines with the switching elements.

6. The motor drive device according to claim 1,
wherein the inverter circuit includes a pair of a first switching element and a second switching element connected in series between a high-potential-side first power-supply line through which drive power of the motor is supplied and a low-potential-side second power-supply line having a lower potential than the first power-supply line for each of a plurality of phases, and
wherein the backup power-supply circuit short-circuits all the phase signal lines by putting all second switching elements connected to second power-supply lines into a conductive state.

7. The motor drive device according to claim 1, wherein the relay switch is a normally closed switch that is in a conductive state when the supply of the electric power from the DC power supply stops.

8. The motor drive device according to claim 1, wherein the motor is a three-phase brushless motor.
